(19) United States
(12) Patent Application Publication
(10) Pub. No.: US 2023/0303425 A1
(43) Pub. Date: Sep. 28, 2023

(54) GLASS COMPOSITION AND SEALING MATERIAL

(71) Applicant: NIPPON ELECTRIC GLASS CO., LTD., Otsu-shi, Shiga (JP)

(72) Inventor: Shoichi SANO, Otsu-shi, Shiga (JP)

(73) Assignee: NIPPON ELECTRIC GLASS CO., LTD., Otsu-shi, Shiga (JP)

(21) Appl. No.: 18/020,277

(22) PCT Filed: Aug. 19, 2021
(86) PCT No.: PCT/JP2021/030409

§ 371 Date: Feb. 8, 2023

(30) Foreign Application Priority Data
Sep. 9, 2020 (JP) 2020-151020

(51) Int. Cl. C03C 3/14; C03C 3/12; C03C 8/24

(52) U.S. Cl. CPC C03C 3/14; C03C 3/122; C03C 8/24

(57) ABSTRACT

A glass composition according to an embodiment of the present invention includes, in mol %, from 1 to 20% of B₂O₃, from 30 to 80% of TeO₂, and from 5 to 30% of MoO₃ as glass composition.

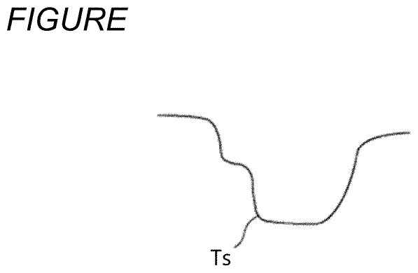

### TECHNICAL FIELD

The present invention relates to a glass composition and a sealing material capable of airtight sealing at low temperatures while having weather resistance.

### BACKGROUND ART

Sealing materials are used in semiconductor integrated circuits, crystal oscillators, metal members, flat display devices, glass terminals for LED terminals, and the like. Sealing materials are required to have chemical durability and heat resistance, and thus glass-based sealing materials are used instead of resin-based adhesives. Sealing materials are further required to have properties, such as mechanical strength, fluidity, and weather resistance. In particular, the sealing temperature is required to be reduced as much as possible for sealing an electronic component on which a heat-sensitive element is mounted. Specifically, sealing materials are required to be capable of sealing at a temperature of 400° C. or lower. As a glass satisfying this property, lead borate-based glass containing a large amount of PbO, which has a great effect of lowering the softening point, has been widely used (see, e.g., Patent Document 1).

### CITATION LIST

### Patent Literature

Patent Document 1: JP S63-315536 A
Patent Document 2: JP 2019-202921 A

### SUMMARY OF INVENTION

### Technical Problem

To reduce the environmental burden, lead borate-based glass is desirably replaced by lead-free glass that includes no PbO. Various types of low softening point lead-free glass have been developed.

However, glass with a lower softening point generally tends to have lower weather resistance. Thus, the glass having both a low softening point and high weather resistance is not readily available. The CuO—TeO₂—MoO₃-based glass described in Patent Document 2 is a promising alternative candidate for lead borate-based glass and has good weather resistance, but its softening point is not adequately low.

In view of the above, an object of the present invention is to provide a glass composition and a sealing material capable of sealing at low temperatures while having good weather resistance.

### Solution to Problem

As a result of diligent studies, the present inventor found that using a certain B₂O₃—TeO₂—MoO₃-based glass can solve the above issues and proposes the present invention. That is, a glass composition according to an embodiment of the present invention includes, in mol %, from 1 to 20% of B₂O₃, from 30 to 80% of TeO₂, and from 5 to 30% of MoO₃ as glass composition.

In addition, in the glass composition according to an embodiment of the present invention, Li₂O+Na₂O+K₂O content is preferably from 0 to 30 mol %. “A+B+C” means a total amount of component A, component B, and component C. For example, “Li₂O+Na₂O+K₂O” refers to a total amount of Li₂O, Na₂O, and K₂O.

Furthermore, in the glass composition according to an embodiment of the present invention, MgO+CaO+SrO+BaO+ZnO content is preferably from 0 to 30 mol %.

Moreover, in the glass composition according to an embodiment of the present invention, TiO₂+Al₂O₃ content is preferably from 0 to 10 mol %.

Also, the glass composition according to an embodiment of the present invention preferably contains in mol % from 0 to 30% of CuO, from 0 to 20% of WO₃, from 0 to 10% of P₂O₅, and from 0 to 10 mol % of Fe₂O₃ as glass composition.

A sealing material according to an embodiment of the present invention preferably contains from 40 to 100 volume % of a glass powder of the glass composition described above and from 0 to 60 volume % of a refractory filler powder.

In addition, in the sealing material according to an embodiment of the present invention, the refractory filler powder is preferably substantially spherical. Here, “substantially spherical” means that the refractory filler powder is not limited to only a true sphere and that a value determined by dividing the shortest diameter passing through the center of gravity of the refractory filler powder by the longest diameter is 0.5 or greater and preferably 0.7 or greater in the refractory filler powder.

Furthermore, in the sealing material according to an embodiment of the present invention, it is preferable that the refractory filler powder is entirely or partially Zr₂WO₄(PO₄)₂.

Moreover, the sealing material according to an embodiment of the present invention is preferably used in a crystal oscillator package.

A sealing material paste according to an embodiment of the present invention preferably contains the sealing material described above and a vehicle.

### Advantageous Effects of Invention

Embodiments of the present invention provide the glass composition and the sealing material capable of sealing at low temperatures while having good weather resistance.

### BRIEF DESCRIPTION OF DRAWINGS

The FIGURE is a schematic view illustrating a measurement curve to be obtained with a macro-differential thermal analyzer.

### DESCRIPTION OF EMBODIMENTS

A glass composition according to an embodiment of the present invention contains in mol % from 1 to 20% of B₂O₃, from 30 to 80% of TeO₂, and from 5 to 30% of MoO₃ as glass composition. The reason for limiting the glass composition range as described above will be described below. In the description regarding the content of each component, “%” means “mol %” unless otherwise indicated.

B₂O₃ is a component for forming a glass network. The B₂O₃ content is from 1 to 20%, preferably from 2 to 15%, and more preferably from 4 to 10%. If the B₂O₃ content is too small, weather resistance may likely deteriorate. On the other hand, if the B₂O₃ content is too large, the viscosity (i.e., the softening point) of the glass may increase, low-temperature sealing may become difficult as well as the glass may be prone to phase separation, and vitrification may become difficult.

TeO₂ is a component for forming a glass network and enhancing weather resistance. The TeO₂ content is from 30 to 80%, preferably from 40 to 70%, and more preferably from 50 to 65%. If the TeO₂ content is too small, the glass may become thermally unstable, and the glass may be prone to devitrification during melting or firing. On the other hand, if the TeO₂ content is too large, the viscosity (i.e., the softening point) of the glass may increase, low-temperature sealing may become difficult as well as the thermal expansion coefficient may tend to be too large.

MoO₃ is a component for forming a glass network. The MoO₃ content is from 5 to 30%, preferably from 7 to 27%, more preferably from 10 to 25%, even more preferably from 12 to 22%, and particularly preferably from 15 to 20%. If the MoO₃ content is too small, vitrification may become difficult as well as the viscosity (i.e., the softening point) of the glass may increase, and low-temperature sealing may become difficult. On the other hand, if the MoO₃ content is too large, the glass may become thermally unstable, and the glass may be prone to devitrification during melting or firing as well as the thermal expansion coefficient may tend to be too large.

In addition to the above components, a component below may be introduced.

Li₂O, Na₂O, and K₂O are components that reduce the viscosity (i.e., the softening point) of the glass. The Li₂O+Na₂O+K₂O content is preferably from 0 to 30%, more preferably from 5 to 25%, and more preferably from 10 to 20%. If the Li₂O+Na₂O+K₂O content is too small, the viscosity (i.e., the softening point) of the glass may increase, and sealing at low temperatures may become difficult. In addition, vitrification may become difficult. On the other hand, if the Li₂O+Na₂O+K₂O content is too large, the glass may become thermally unstable, and the glass may be prone to devitrification during melting or firing. In addition, weather resistance may likely deteriorate as well as the thermal expansion coefficient may tend to be too large.

Li₂O is a component for significantly reducing the viscosity (i.e., the softening point) of the glass compared with Na₂O and K₂O. The Li₂O content is preferably from 0 to 30%, more preferably from 1 to 20%, even more preferably from 3 to 15%, and particularly preferably from 5 to 13%. If the Li₂O content is too small, the viscosity (i.e., the softening point) of the glass may increase, and sealing at low temperatures may become difficult. In addition, vitrification may become difficult. On the other hand, if the Li₂O content is too large, the glass may become thermally unstable, and the glass may be prone to devitrification during melting or firing. In addition, weather resistance may likely deteriorate as well as the thermal expansion coefficient may tend to be too large.

Na₂O is a component for reducing the viscosity (i.e., the softening point) of the glass compared with K₂O. The Na₂O content is preferably from 0 to 20%, more preferably from 0 to 15%, even more preferably from 0 to 10%, and particularly preferably from 1 to 7%. If the Na₂O content is too small, the viscosity (i.e., the softening point) of the glass may increase, and sealing at low temperatures may become difficult. In addition, vitrification may become difficult. On the other hand, if the Na₂O content is too large, the glass may become thermally unstable, and the glass may be prone to devitrification during melting or firing. In addition, weather resistance may likely deteriorate as well as the thermal expansion coefficient may tend to be too large.

K₂O is a component for reducing the viscosity (i.e., the softening point) of the glass. The K₂O content is preferably from 0 to 30%, more preferably from 1 to 20%, even more preferably from 3 to 15%, and particularly preferably from 5 to 13%. If the K₂O content is too small, the viscosity (i.e., the softening point) of the glass may increase, and sealing at low temperatures may become difficult. In addition, vitrification may become difficult. On the other hand, if the K₂O content is too large, the glass may become thermally unstable, and the glass may be prone to devitrification during melting or firing. In addition, weather resistance may likely deteriorate as well as the thermal expansion coefficient may tend to be too large.

To reduce the softening point by the alkali mixing effect, the molar ratio Li₂O/K₂O is preferably from 0.3 to 5, more preferably from 0.4 to 4, from 0.5 to 3, even more preferably from 0.6 to 2, and particularly preferably from 0.7 to 1.5. If the molar ratio Li₂O/K₂O is outside the above range, the glass may become thermally unstable, and the glass may be prone to devitrification during melting or firing. “Li₂O/K₂O” refers to a value obtained by dividing the content of Li₂O by the content of K₂O.

MgO, CaO, SrO, BaO, and ZnO are components that extend the vitrification range and improve weather resistance. MgO+CaO+SrO+BaO+ZnO is preferably from 1 to 30%, more preferably from 3 to 20%, and even more preferably from 5 to 15%. If the MgO+CaO+SrO+BaO+ZnO content is too small, the viscosity (i.e., the softening point) of the glass may increase, and sealing at low temperatures may become difficult. In addition, vitrification may become difficult. On the other hand, if the MgO+CaO+SrO+BaO+ZnO content is too large, the glass may become thermally unstable, and the glass may be prone to devitrification during melting or firing. In addition, weather resistance may likely deteriorate as well as the thermal expansion coefficient may tend to be too large.

MgO is a component for extending the vitrification range and improving weather resistance. The MgO content is preferably from 0 to 25%, more preferably from 0 to 20%, even more preferably from 0 to 10%, and particularly preferably from 1 to 7%. If the MgO content is small, vitrification may become difficult. In addition, the viscosity (i.e., the softening point) of the glass may increase, and sealing at low temperatures may become difficult. On the other hand, if the MgO content is too large, the glass may become thermally unstable, and the glass may be prone to devitrification during melting or firing. In addition, weather resistance may likely deteriorate as well as the thermal expansion coefficient may tend to be too large.

CaO is a component for extending the vitrification range and improving weather resistance. The CaO content is preferably from 0 to 25%, more preferably from 0 to 20%, even more preferably from 0 to 10%, and particularly preferably from 1 to 7%. If the CaO content is small, vitrification may become difficult. In addition, the viscosity (i.e., the softening point) of the glass may increase, and sealing at low temperatures may become difficult. On the other hand, if the CaO content is too large, the glass may become thermally unstable, and the glass may be prone to devitrification during melting or firing. In addition, weather resistance may likely deteriorate as well as the thermal expansion coefficient may tend to be too large.

SrO is a component for extending the vitrification range and improving weather resistance. The SrO content is preferably from 0 to 25%, more preferably from 0 to 20%, even more preferably from 0 to 10%, and particularly preferably from 1 to 7%. If the SrO content is small, vitrification may become difficult. In addition, the viscosity (i.e., the softening point) of the glass may increase, and sealing at low temperatures may become difficult. On the other hand, if the SrO content is too large, the glass may become thermally unstable, and the glass may be prone to devitrification during melting or firing. In addition, weather resistance may likely deteriorate as well as the thermal expansion coefficient may tend to be too large.

BaO is a component for extending the vitrification range and improving weather resistance. The BaO content is preferably from 0 to 25%, more preferably from 0 to 20%, even more preferably from 0 to 10%, and particularly preferably from 1 to 7%. If the BaO content is small, vitrification may become difficult. In addition, the viscosity (i.e., the softening point) of the glass may increase, and sealing at low temperatures may become difficult. On the other hand, if the BaO content is too large, the glass may become thermally unstable, and the glass may be prone to devitrification during melting or firing. In addition, weather resistance may likely deteriorate as well as the thermal expansion coefficient may tend to be too large.

ZnO is a component for extending the vitrification range and improving weather resistance. The ZnO content is preferably from 0 to 25%, more preferably from 0 to 20%, even more preferably from 0 to 10%, and particularly preferably from 1 to 7%. If the ZnO content is too small, vitrification may become difficult. In addition, the viscosity (i.e., the softening point) of the glass may increase, and low-temperature sealing may become difficult. On the other hand, if the ZnO content is too large, the glass may become thermally unstable, and the glass may be prone to devitrification during melting or firing. In addition, weather resistance may likely deteriorate as well as the thermal expansion coefficient may tend to be too large.

TiO₂ and Al₂O₃ are components for improving weather resistance. The TiO₂+Al₂O₃ content is preferably from 0 to 10%, more preferably from 0.1 to 8%, even more preferably from 1 to 6%, and particularly preferably from 2 to 5%. If the TiO₂+Al₂O₃ content is too large, the viscosity (i.e., the softening point) of the glass may increase, and low-temperature sealing may become difficult.

Al₂O₃ is a component for improving weather resistance. The Al₂O₃ content is preferably from 0 to 10%, more preferably from 0.1 to 8%, even more preferably from 1 to 6%, and particularly preferably from 2 to 5%. If the Al₂O₃ content is too large, the viscosity (i.e., the softening point) of the glass may increase, and low-temperature sealing may become difficult.

TiO₂ is a component for improving weather resistance. The TiO₂ content is preferably from 0 to 8%, more preferably from 0.1 to 6%, even more preferably from 1 to 5%, and particularly preferably from 2 to 4%. If the TiO₂ content is too large, the viscosity (i.e., the softening point) of the glass may increase, and low-temperature sealing may become difficult.

CuO is a component for reducing the viscosity (i.e., the softening point) of the glass and reducing the thermal expansion coefficient. In addition, CuO is a component for increasing adhesion strength of glass and metal in sealing metal. Although the mechanism of increasing the adhesion strength is unknown at present, Cu atoms have high diffusivity and thus diffuse from the surface toward the inside of the metal, and this presumably facilitates the integration of glass and metal. The type of metal to be sealed is not particularly limited, but examples include iron, iron alloys, nickel, nickel alloys, copper, copper alloys, aluminum, and aluminum alloys. The CuO content is preferably from 0 to 30%, more preferably from 0 to 10%, even more preferably from 0.1 to 5%, and particularly preferably from 0.5 to 3%. In addition, the CuO content in sealing metal is preferably from 1 to 30%, more preferably from 1 to 20%, more preferably from 3 to 15%, and particularly preferably from 5 to 10%. If the CuO content is too large, the glass may become thermally unstable, and the metal Cu precipitates from the glass surface in the sealing process. This may adversely affect the sealing strength and electrical properties, and the glass may be prone to devitrification during melting or firing.

WO₃ is a component for reducing the thermal expansion coefficient. The WO₃ content is preferably from 0 to 20%, from 0.1 to 10%, and particularly from 1 to 5%. If the WO₃ content is too large, the glass may become thermally unstable, and the glass may be prone to devitrification during melting or firing as well as the viscosity (i.e., the softening point) of the glass may increase, and low-temperature sealing may become difficult.

P₂O₅ is a component for forming a glass network and thermally stabilizing the glass. The P₂O₅ content is preferably from 0 to 10%, more preferably from 0.1 to 5%, even more preferably from 0.2 to 2%, and particularly preferably from 0.5 to 1%. If the P₂O₅ content is too large, the viscosity (i.e., the softening point) of the glass may increase, and low-temperature sealing may become difficult as well as weather resistance may likely deteriorate.

Fe₂O₃ is a component for increasing reactivity with an object to be sealed. The Fe₂O₃ content is preferably from 0 to 25%, more preferably from 0 to 20%, even more preferably from 0 to 10%, and particularly preferably from 1 to 7%. If the Fe₂O₃ content is too large, vitrification may become difficult as well as the viscosity (i.e., the softening point) of the glass may increase, and low-temperature sealing may become difficult.

Ag₂O is a component for reducing the viscosity (i.e., the softening point) of the glass. The Ag₂O content is preferably from 0 to 10%, more preferably from 0 to 5%, even more preferably from 0 to 3%, and particularly preferably from 0 to 2%. If the Ag₂O content is too large, the glass may become thermally unstable, and the glass may be prone to devitrification during melting or firing. In addition, metal Ag may precipitate from the glass depending on the firing atmosphere.

AgI is a component for reducing the viscosity (i.e., the softening point) of the glass. The AgI content is preferably from 0 to 10%, more preferably from 0 to 5%, even more preferably from 0 to 2%, and particularly preferably from 0 to 1%. If the AgI content is too large, the thermal expansion coefficient may tend to be too large.

Nb₂O₅ is a component for thermally stabilizing the glass and increasing weather resistance. The Nb₂O₅ content is preferably from 0 to 10%, more preferably from 0 to 5%, even more preferably from 0 to 2%, and particularly preferably from 0 to 1%. If the Nb₂O₅ content is too large, the viscosity (i.e., the softening point) of the glass may increase, and low-temperature sealing may likely be difficult.

V₂O₅ is a component for forming a glass network and reducing the viscosity (i.e., the softening point) of the glass. The V₂O₅ content is preferably from 0 to 10%, more preferably from 0 to 5%, even more preferably from 0 to 3%, and even more preferably from 0 to 2%. If the V₂O₅ content is too large, the glass may become thermally unstable, and the glass may be prone to devitrification during melting or firing as well as weather resistance may likely deteriorate.

Ga₂O₃ is a component for thermally stabilizing the glass and increasing weather resistance but is very expensive. Thus, the content is preferably less than 0.01%.

GeO₂, Nb₂O₅, CeO₂, Sb₂O₃, and La₂O₃ are components that thermally stabilize the glass and prevent devitrification, each of which can be added up to less than 5%. If the content of these is too large, the glass may become thermally unstable, and the glass may be prone to devitrification during melting or firing.

The glass composition according to an embodiment of the present invention preferably contains substantially no PbO for environmental reasons. Here, “contains substantially no PbO” refers to a case where the PbO content in the glass composition is less than 0.1%.

A sealing material according to an embodiment of the present invention contains a glass powder including the glass composition described above. The sealing material according to an embodiment of the present invention may contain a refractory filler powder to improve mechanical strength or adjust the thermal expansion coefficient. The mixing ratio is preferably from 40 to 100 volume % of the glass powder and from 0 to 60 volume % of the refractory filler powder, more preferably from 50% to 99 volume % of the glass powder and from 1 to 50 volume % of the refractory filler powder, even more preferably from 60 to 95 volume % of the glass powder and from 5 to 40 volume % of the refractory filler powder, and particularly preferably from 70 to 90 volume % of the glass powder and from 10 to 30 volume % of the refractory filler powder. If the content of the refractory filler powder is too large, the proportion of the glass powder may become relatively small, and thus a desired fluidity may become difficult to ensure.

The refractory filler powder preferably contains Zr₂WO₄(PO₄)₂. Zr₂WO₄(PO₄)₂ has properties of hardly reacting with the glass powder according to an embodiment of the present invention and further significantly reducing the thermal expansion coefficient of the sealing material.

In addition, for the sealing material according to an embodiment of the present invention, a refractory filler powder other than Zr₂WO₄(PO₄)₂ can also be used as the refractory filler powder. Examples of such another refractory filler powder include powders made of NbZr(PO₄)₃, Zr₂MoO₄(PO₄)₂, Hf₂WO₄(PO₄)₂, Hf₂MoO₄(PO₄)₂, zirconium phosphate, zircon, zirconia, tin oxide, aluminum titanate, quartz, β-spodumene, mullite, titania, quartz glass, β-eucryptite, β-quartz, willemite, cordierite, or Sr_{0.5}Zr₂(PO₄)₃. Such a powder can be used individually, or two or more of such powders can be mixed and used.

The refractory filler powder is preferably substantially spherical. Such a refractory filler powder is less likely to inhibit the fluidity of the glass powder when the glass powder is softened, resulting in the improvement of the fluidity of the sealing material. In addition, this makes it easier to obtain a smooth glaze layer. Furthermore, even if a portion of the refractory filler powder is exposed to the surface of the glaze layer, the stress of this portion may be dispersed because of the substantially spherical shape of the refractory filler powder. This is less likely to apply improper stress to an object to be sealed and easily ensures airtightness even when the object to be sealed is brought into contact with the glaze layer upon sealing.

The average particle size D₅₀ of the refractory filler powder is preferably from 0.2 to 20 μm and particularly preferably from 2 to 15 μm. If the average particle size D₅₀ is too large, the sealing layer may be likely to become thicker. On the other hand, if the average particle size D₅₀ is too small, the refractory filler powder may be eluted into the glass during sealing, and the glass may be prone to devitrification.

In the sealing material according to an embodiment of the present invention, the softening point is preferably 350° C. or lower and particularly preferably 340° C. or lower. If the softening point is too high, the viscosity of the glass may increase, thus the sealing temperature may increase, and the heat during sealing may degrade the element. The lower limit of the softening point is not particularly limited but is realistically 180° C. or higher. Here, the “softening point” refers to a value determined by measuring a sealing material with an average particle size D₅₀ of 0.5 to 20 μm as a measurement sample with a macro-differential thermal analyzer. The measurement conditions include starting the measurement from room temperature and a rate of temperature increase of 10° C./minute. The softening point measured with a macro-differential thermal analyzer refers to the temperature (Ts) of the fourth inflection point on the measurement curve illustrated in the FIGURE.

In the sealing material according to an embodiment of the present invention, the thermal expansion coefficient in a temperature range of 30 to 150° C. is preferably from 20×10⁻⁷/° C. to 200×10⁻⁷/° C., more preferably from 30×10⁻⁷/° C. to 160×10⁻⁷/° C., even more preferably from 40×10⁻⁷/° C. to 140×10⁻⁷/° C., and particularly preferably from 50×10⁻⁷/° C. to 120×10⁻⁷/° C. If the thermal expansion coefficient is outside the above range, the thermal expansion difference between the sealing material and a material to be sealed may make the sealing portion easy to break during or after sealing.

Next, an example of a manufacturing method and a use method of the glass powder and the sealing material according to an embodiment of the present invention will be described.

First, a raw material powder mixed to give glass composition as desired is melted at 800 to 1000° C. for 1 to 2 hours until homogeneous glass is obtained. Next, the resulting molten glass is formed into a film shape or the like, and then this is ground and classified to produce the glass powder. The average particle size D₅₀ of the glass powder is preferably approximately from 1 to 20 μm. As necessary, a refractory filler powder of various types is added to and mixed with the glass powder to form the sealing material.

Next, a vehicle is added to and kneaded with the sealing material to prepare a sealing material paste. The vehicle is mainly made of an organic solvent and a resin, and the resin is added to adjust the viscosity of the paste. In addition, a surfactant, a thickener, or the like can also be added as necessary.

The organic solvent preferably has a low boiling point (i.e., a boiling point of 300° C. or lower), leaves little residue after firing, and does not deteriorate the glass. The content is preferably from 10 to 40 mass %. Examples of the organic solvent that is preferably used include propylene carbonate, toluene, N,N′-dimethylformamide (DMF), 1,3-dimethyl-2-imidazolidinone (DMI), dimethyl carbonate, butyl carbitol acetate (BCA), isoamyl acetate, dimethyl sulfoxide, acetone, and methyl ethyl ketone. In addition, a higher alcohol is more preferably used as the organic solvent. The higher alcohol itself has viscosity and thus can be formed into a paste without adding any resin to the vehicle. Furthermore, pentanediol and its derivatives, specifically diethylpentanediol (C₉H₂₀O₂), have excellent viscosity and thus can be used as the solvent.

The resin preferably has a low decomposition temperature, leaves little residue after firing, and hardly deteriorate the glass. The content is preferably from 0.1 to 20 mass %. Examples of the resin that is preferably used include nitrocellulose, polyethylene glycol derivatives, polyethylene carbonate, and acrylic esters (acrylic resins).

The sealing material paste is then applied to the sealing portion of an object to be sealed, the object made of metal, ceramic, or glass, using a coating machine, such as a dispenser or a screen printer, dried, and glazed at 300 to 350° C. Another object to be sealed is then brought into contact with and heat-treated at 350 to 400° C. to allow the glass powder to soften and flow, and both are sealed.

The glass powder according to an embodiment of the present invention can be used for purposes, such as coating or filling, in addition to sealing applications. In addition, the glass powder can also be used in a form other than the paste, specifically such as a powder, a green sheet, or a tablet (a form prepared by sintering the powder material into a given form).

### EXAMPLES

The present invention will be described in detail based on examples. Table 1 illustrates examples of the present invention (Sample Nos. 1 to 10) and comparative examples (Sample Nos. 11 and 12).

TABLE 1

| | | No. 1 | No. 2 | No. 3 | No. 4 | No. 5 | No. 6 | No. 7 | No. 8 | No. 9 | No. 10 | No. 11 | No. 12 |
|---|---|---|---|---|---|---|---|---|---|---|---|---|---|
| Glass | B₂O₃ | 4 | 4 | 4 | 4 | 4 | 4 | 10 | 5 | 6 | 3 | 35 | |
| composition | TeO₂ | 62 | 62 | 62 | 62 | 62 | 56 | 59 | 47 | 58 | 67 | 38 | 62 |
| (mol %) | MoO₃ | 10 | 10 | 10 | 10 | 10 | 10 | 5 | 30 | 9 | 9 | 9 | 13 |
| | Li₂O | 9 | 9 | 9 | 9 | 9 | 10 | 9 | 6 | 10 | 8 | 9 | 8 |
| | Na₂O | | | | | | | | 6 | | | 9 | 9 |
| | K₂O | 9 | 9 | 9 | 9 | 9 | 10 | 9 | 6 | 8 | 10 | | |
| | MgO | 6 | | | | | | | | | | | |
| | CaO | | 6 | | | | 4 | | | | | | 6 |
| | SrO | | | 6 | | | | 4 | | | | | |
| | BaO | | | | 6 | | | | | | | | |
| | ZnO | | | | | 6 | | | | | | | |
| | TiO₂ | | | | | | 2 | | | | | | 2 |
| | Al₂O₃ | | | | | | 4 | | | | | | |
| | CuO | | | | | | | 4 | | | | | |
| | WO₃ | | | | | | | | | 4 | | | |
| | P₂O₅ | | | | | | | | | | 3 | | |
| | Fe₂O₃ | | | | | | | | | 5 | | | |
| | Li₂O + Na₂O + K₂O | 18 | 18 | 18 | 18 | 18 | 20 | 18 | 18 | 18 | 18 | 18 | 17 |
| | MgO + CaO + SrO + | 6 | 6 | 6 | 6 | 6 | 4 | 4 | 0 | 0 | 0 | 0 | 6 |
| | BaO + ZnO | | | | | | | | | | | | |
| | TiO₂ + Al₂O₃ | 0 | 0 | 0 | 0 | 0 | 6 | 0 | 0 | 0 | 0 | 0 | 2 |

| | | | | | | | | | | | | |
|---|---|---|---|---|---|---|---|---|---|---|---|---|
| Refractory filler powder | ZWP | ZWP | NZP | ZWP | ZWP | ZWP | ZWP | ZWP | ZWP | NZP | Not | ZWP |
| (volume %) | 20 | 20 | 45 | 20 | 20 | 20 | 20 | 20 | 20 | 40 | vitrified | 20 |
| Glass transition point (° C.) | 277 | 276 | 276 | 273 | 278 | 282 | 297 | 291 | 292 | 287 | | 292 |
| Thermal expansion coefficient | 73 | 73 | 74 | 76 | 76 | 70 | 69 | 72 | 71 | 73 | | 71 |
| (×10⁻⁷/° C.) | | | | | | | | | | | | |
| Softening point (° C.) | 335 | 331 | 330 | 328 | 333 | 347 | 350 | 343 | 344 | 341 | | 344 |
| Fluidity | Good | Good | Good | Good | Good | Good | Good | Good | Good | Good | | Good |
| Weather resistance | Good | Good | Good | Good | Good | Good | Good | Good | Good | Good | | Poor |

First, a raw material powder mixed to give the glass composition as listed in the table, was placed in a platinum crucible and melted at 800 to 1000° C. in the air for 1 to 2 hours. The molten glass was then formed into a film shape with a water-cooled roller. The film-shaped glass was ground with a ball mill and then passed through a sieve with an opening of 75 μm, and a glass powder with an average particle size D₅₀ of about 10 μm was obtained.

The resulting glass powder was then mixed with a refractory filler powder as listed in the table, and a mixed powder was obtained.

The refractory filler powders used were substantially spherical Zr₂WO₄(PO₄)₂, which is denoted as ZWP in the table, and NbZr(PO₄)₃, which is denoted as NZP in the table. The average particle size D₅₀ of the refractory filler powder was about 10 μm.

Samples Nos. 1 to 12 were evaluated for the glass transition point, thermal expansion coefficient, softening point, fluidity, and weather resistance.

The thermal expansion coefficient at the glass transition point and a temperature range of 30 to 150° C. was evaluated as follows. First, the mixed powder was placed in a bar-shaped mold, press-molded, and then fired at 380° C. for 10 minutes on an alumina substrate coated with a release agent. Thereafter, the fired body was processed into a predetermined shape and measured with a TMA apparatus.

The softening point was measured with a macro-differential thermal analyzer, and the fourth inflection point was taken as the softening point. The measurement atmosphere was in the air, the rate of temperature increase was 10° C./min, and the measurement was started from room temperature.

The fluidity was evaluated as follows. The mixed powder of the mass of the combined density of the mixed powder was placed in a mold with a size of 20 mm, press-molded, and then fired at 380° C. for 10 minutes on a glass substrate. A fired body with a flow diameter of 19 mm or greater was rated as “good”, and a fired body with a flow diameter of less than 19 mm was rated as “poor”.

The weather resistance was evaluated by an accelerated degradation test according to a pressure cooker test (PCT). Specifically, the fired body produced above was held in an environment at 121° C., 2 atm, and a relative humidity of 100% for 24 hours and then visually observed. A fired body with no precipitate from the surface was rated as “good” and otherwise as “poor”.

As is clear from the table, sample Nos. 1 to 10 were well evaluated for fluidity and weather resistance. On the other hand, sample No. 11 contained a large amount of B₂O₃ in the glass composition and thus did not vitrify. Sample No. 12 contained no B₂O₃ in the glass composition and thus had poor weather resistance.

### INDUSTRIAL APPLICABILITY

The glass composition according to an embodiment of the present invention is suitable for sealing a crystal oscillator package and in addition, suitable for sealing an airtight package, such as those of a semiconductor integrated circuit, a flat display device, a glass terminal for an LED, and an aluminum nitride substrate. In addition, the glass composition can also be used as a sealing material for metal.

1: A glass composition comprising, in mol %, from 1 to 20% of B₂O₃, from 30 to 80% of TeO₂, and from 5 to 30% of MoO₃ as glass composition.

2: The glass composition according to claim 1, further comprising from 0 to 30 mol % of Li₂O+Na₂O+K₂O.

3: The glass composition according to claim 1, further comprising from 0 to 30 mol % of MgO+CaO+SrO+BaO+ZnO.

4: The glass composition according to claim 1, further comprising from 0 to 10 mol % of TiO₂+Al₂O₃.

5: The glass composition according to claim 1, further comprising, in mol %, from 0 to 30% of CuO, from 0 to 20% of WO₃, from 0 to 10% of P₂O₅, and from 0 to 10 mol % of Fe₂O₃ as glass composition.

6: A sealing material comprising from 40 to 100 volume % of a glass powder including the glass composition according to claim 1, and from 0 to 60 volume % of a refractory filler powder.

7: The sealing material according to claim 6, wherein the refractory filler powder is substantially spherical.

8: The sealing material according to claim 6, wherein the refractory filler powder comprises entirely or partially Zr₂WO₄(PO₄)₂.

9: The sealing material according to claim 6 for use in a crystal oscillator package.

10: A sealing material paste comprising the sealing material according to claim 6 and a vehicle.
